(19) United States
(12) Patent Application Publication
(10) Pub. No.: US 2026/0134593 A1
(43) Pub. Date: May 14, 2026

(54) Selecting and Placing Objects in Images

(71) Applicant: Microsoft Technology Licensing, LLC, Redmond, WA (US)

(72) Inventors: Eric Chris Wolfgang SOMMERLADE, Oxford (GB); Alexandros NEOFYTOU, London (GB); Mohsen FAYYAZ, Berlin (DE); Marcelo GENNARI DO NASCIMENTO, London (GB); Mohamad SHAHBAZI, Zurich (CH)

(73) Assignee: Microsoft Technology Licensing, LLC, Redmond, WA (US)

(21) Appl. No.: 18/942,823

(22) Filed: Nov. 11, 2024

(51) Int. Cl. G06T 11/60; G06T 5/77; G06V 10/774

(52) U.S. Cl. CPC G06T 11/60; G06T 5/77; G06V 10/774; G06T 2210/61

(57) ABSTRACT

A technique uses a machine-trained model to determine one or more objects to be added to an input image and the locations of those objects. In some applications, the technique synthesizes an output image based on the identified objects and locations. The machine-trained model is trained by: removing objects in original images; using the machine-trained model to predict the objects that have been removed and the locations of the objects; and adjusting weights of the machine-trained model to increase accuracy at which the machine-trained model subsequently predicts the objects that have been removed and the locations of the objects. Other implementations extend the technique to placing objects in the frames of input video sequences.

### BACKGROUND

Machine-trained models are capable of performing various image analysis tasks, such as object detection, image segmentation, and depth and surface estimation. Generative models, such as generative adversarial networks (GANs) and diffusion models, have also proven effective in synthesizing realistic looking images.

### SUMMARY

A technique is described for training and applying a machine-trained model that is capable of selecting suitable objects to place in an image and choosing the locations at which to place the objects. In so doing, the technique expands its analysis to what could be added to a scene, in which the content that is already in the scene serves as context. The technique is capable of performing its analysis in the inference stage without considering specific images of candidate objects.

In some examples, the technique operates on a standalone image. In other examples, the technique operates on a single frame in a stream of video information. In other examples, the technique operates on plural frames of video information. As used herein, an “image” refers to any of a standalone image, a standalone frame, a frame in a video sequence, etc.

In one mode of operation, input is received that specifies a region of interest in an image, and the machine-trained model is tasked with selecting a suitable object to place in the region of interest. In another mode of operation, input is received that specifies an object of interest, and the machine-trained model is tasked with selecting a suitable location to place the object of interest in the image. In another mode of operation, the machine-trained model is asked to choose both the object to place in the image and its location, having been supplied neither the object nor its location. In another mode of operation, the machine-trained model is asked to place an object in plural frames of an input video sequence, in which the object is specified in the input instructions, or the location is specified in the input instructions, or neither the object nor its location are specified in the input instructions. In some examples, this task involves selecting a starting frame at which the object will first appear and selecting a trajectory that defines a path of the object over subsequent frames in the input video sequence. In all cases, the machine-trained model is asked to supplement the image (or images) in a way that is not fully specified by the input instructions or the image(s) in their original form.

In some implementations, the technique further includes synthesizing an output image based on the result information. The output image includes the selected object placed at the selected location. In other examples, the technique synthesizes an output video sequence. Other applications use the result information for other purposes, such as controlling a robot.

In some implementations, the technique includes training the machine-trained model by: receiving original images in which objects are identified; removing the objects in the original images; predicting the objects that have been removed and the locations of the objects; and adjusting the weights of the machine-trained model to increase accuracy at which the machine-trained model subsequently predicts the objects that have been removed and the locations of the objects. In some implementations, the removing in the training process involves reconstructing the original images without the objects by performing inpainting.

In other implementations, the training further encompasses, for each training example, predicting a starting frame and a trajectory, and comparing the predicted starting frame and the predicted trajectory to a ground-truth starting frame and a ground-truth trajectory.

Among other technical benefits, the technique performs complex analysis of the input image (or images) based on what is currently depicted in the input image(s) and what might be added to the input image(s). This complex analysis reduces the amount of time and labor that would otherwise go into manually revising the input image(s). In addition, or alternatively, the technique reduces the ad hoc application of separate tools in revising the input image(s) and the resources consumed thereby. The technique also reduces the incidence of visual incongruities and other artifacts that may arise due to the placement and integration of objects at inappropriate locations in output images.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an image-processing system for choosing objects and placing the objects in images.

FIG. 2 shows a first implementation of the image-processing system of FIG. 1 that uses an auto-regressive language model.

FIG. 3 shows a second implementation of the image-processing system of FIG. 1 that uses a classifier model.

FIG. 4 shows details regarding one manner of operation of the classifier model of FIG. 3.

FIG. 5 shows an example of the use of the image-processing system of FIG. 1 in which a location is specified as an input condition.

FIG. 6 shows an example of the use of the image-processing system of FIG. 1 in which an object is specified as an input condition.

FIG. 7 shows an example in which the image-processing system of FIG. 1 proposes plural candidate locations.

FIG. 8 shows an example of a shopping-related application that uses the image-processing system of FIG. 1.

FIG. 9 shows two flows of analysis that the image-processing system of FIG. 1 is capable of taking in processing an open-ended request to add at least one object to an image.

FIG. 10 shows an example in which the image-processing system of FIG. 1 adds an object to an input video sequence, which involves selecting a starting frame in which the object first appears and a trajectory of the object over subsequent frames.

FIG. 11 shows three different ways of training the image-processing system of FIG. 1.

FIG. 12 shows a training system for training the image-processing system of FIG. 1.

FIG. 13 shows an example-generating system for generating training examples for use by the training system of FIG. 12.

FIG. 14 shows a training example produced by the example-generating system of FIG. 13.

FIG. 15 shows one approach for fine-tuning weights of a pretrained language model.

FIG. 16 shows an illustrative language model for implementing an object selection and placement component (OSPC) in the image-processing system FIG. 1.

FIG. 17 shows a convolutional neural network for implementing the OSPC in the image-processing system of FIG. 1.

FIG. 18 shows an illustrative diffusion model for implementing an image-synthesizing component in the image-processing system of FIG. 1.

FIG. 19 is a flowchart that provides an overview of one manner of operation of the image-processing system of system of FIG. 1.

FIG. 20 is a flowchart that provides an overview of one manner of operation of the training system of FIG. 12.

FIG. 21 shows computing equipment that, in some implementations, is used to implement the image-processing system of FIG. 1 and the training system of FIG. 11.

FIG. 22 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. System and Method for Choosing and Placing Objects

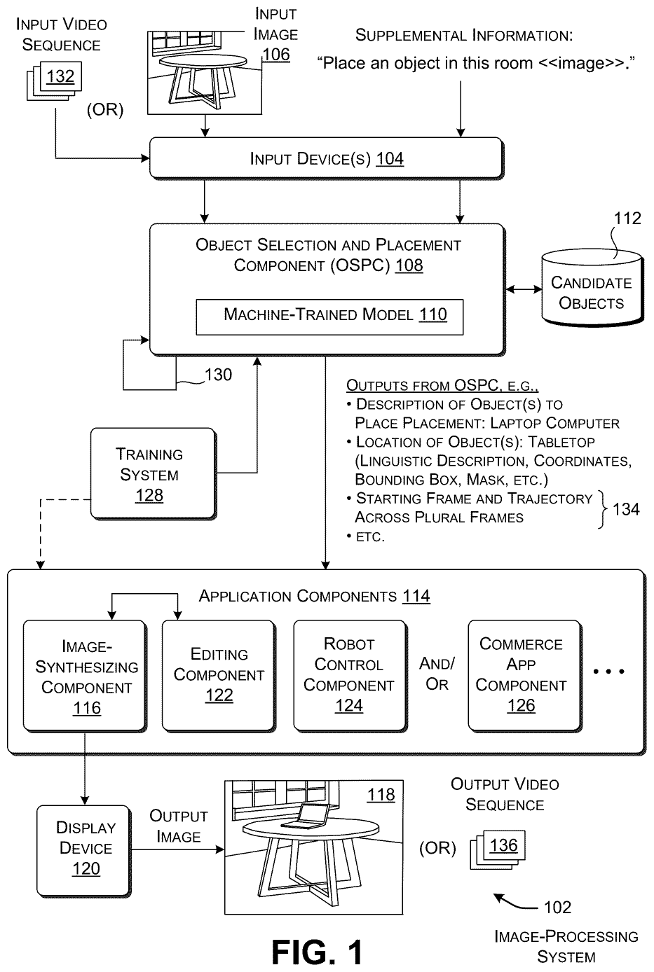

FIG. 1 shows an image-processing system 102 that handles different kinds of object placement requests in different modes of operations. A first type of request asks the image-processing system 102 to choose both an object and its location, without being supplied either. A second type of request asks the image-processing system 102 to select a suitable object of interest to be placed in a specified region. A third type of request asks the image-processing system 102 to choose a suitable location in the input image 106 in which to place a specified object. A fourth type of request asks the image-processing system 102 to add an object to an input video sequence in situations in which a) the object is specified but the location is not specified, or b) the location is specified but the object is not specified, or c) neither the object nor its location are specified. The image-processing system 102 is capable of handling yet additional variations of object location requests.

To facilitate explanation, this section first explains the image-processing system 102 as applied to the task of placing objects in single images or single frames of video sequences. The explanation will then advance to implementations of the image-processing system 102 that are capable of placing an object across the frames of an input video sequence. The principles also apply to placing objects in three-dimensional data, e.g., in which depth information is captured by a depth camera. Examples of depth cameras include the RealSense depth camera by INTEL CORPORATION of Santa Clara, California and any 3D camera produced by ORBBEC INC. of Shenzhen, China. The term “image’ is to be understood as encompassing at least a standalone image, a frame of video information, and a frame of 3D information.

The following terminology is relevant to some examples presented below. A “machine-trained model” or “model” refers to computer-implemented logic for executing a task using machine-trained weights that are produced in a training operation. A “weight” refers to any type of parameter value that is iteratively produced by the training operation. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “prompt” refers to a sequence of tokens submitted to a machine-trained model. A “distributed vector” expresses the semantic content of an information item by distributing information over its k dimensions (in contrast to a one-hot vector that allocates particular dimensions of the vector to particular concepts). In some contexts, terms such as “component,” “module,” “engine,” and “tool” refer to parts of computer-based technology that perform respective functions. FIGS. 22 and 22, described below, provide examples of illustrative computing equipment for performing these functions.

With respect to placing objects in standalone images, the image-processing system 102 includes one or more input devices 104 for supplying an input image 106 and/or a depth map. For example, one such input device is a camera for capturing an image or a video. Another input device is a retrieval tool for retrieving a previously created image from a remote or local data store.

Other input devices supply supplemental information that informs the image-processing system 102 of what task it is to perform. For example, one such other input device is a keyboard and/or a speech recognition component by which the user is able to specify an object of interest to be placed in the input image 106, or to specify more open-ended instruction information in textual form that informs the image-processing system 102 what task it is to perform. In the example of FIG. 1, the instruction information expresses the open-ended request, “Place an object in this room.” In addition, or alternatively, the other input devices include a graphical user interface by which a user is able to specify a location in the input image 106, e.g., by specifying a point or a region (e.g., a bounding box). These supplemental inputs are optional; in their absence, the image-processing system 102 is automatically configured to identify one or more objects to be placed in the input image 106 and their respective locations.

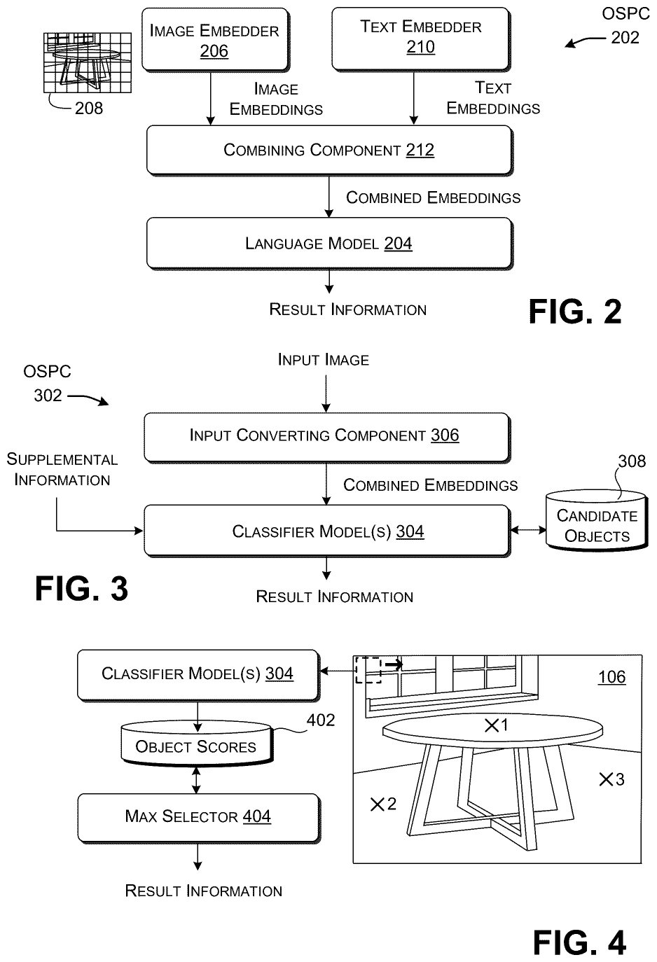

An object selection and placement component (OSPC) 108 uses a machine-trained model 110 to transform the combined embeddings into result information that specifies: a) the object(s) to be placed in the input image 106 (if not already given); and b) the location(s) at which to place the object(s) in the input image 106 (if not already given). In FIG. 1, the result information specifies that a laptop computer is to be placed on the tabletop shown in the input image 106. In some implementations, the machine-trained model 110 is a language model, such as a transformer-based language model that operates in an auto-regressive manner. In other implementations, the machine-trained model 110 is a classifier model, such as a convolutional neural network. FIGS. 2-4 describe these two implementations in greater detail. Section D provides yet further details regarding illustrative machine-trained models.

From a high-level perspective, the OSPC 108 implicitly treats the content that is already in a scene as context that influences what could be added to the scene. In other words, the OSPC 108 can be said to choose and place objects that complement the objects and other content already present in a scene. The OSPC 108 implicitly asks and answers the question, “What would complete this picture?” This query is open-ended insofar as it does not fully specify the object to be added and/or the location at which the object should be added to the input image 106.

Different implementations of the OSPC 108 are trained to specify each object and each location in different ways. For example, the OSPC 108 specifies an object by specifying its category name, its identifier, and/or distributed vectors that convey the identity of the object. The OSPC 108 specifies a location by giving a verbal description of the location (“on top of the table”), the coordinates of its location, the coordinates of a bounding box or other shape that will contain the object, and/or an image mask that specifies the outline or profile of the object when placed in the input image 106.

In some implementations, the OSPC 108 is constrained to choose one or more candidate objects from a set of candidate objects. A data store 112 provides information regarding each candidate object, including any of its identifier (e.g., product name or ID), category, semantic vector(s), etc. In other examples, the OSPC 108 does not explicitly specify a set of candidate objects, but rather relies on the knowledge acquired by the machine-trained model 110 in training to recommend an object. That is, insofar as the machine-trained model 110 has encountered various objects during its training, the weights of the machine-trained model 110 encode information about these objects. The machine-trained model 110, if implemented as a language model, is also capable of extending what it has learned to new objects, which may not have been encountered in the training examples.

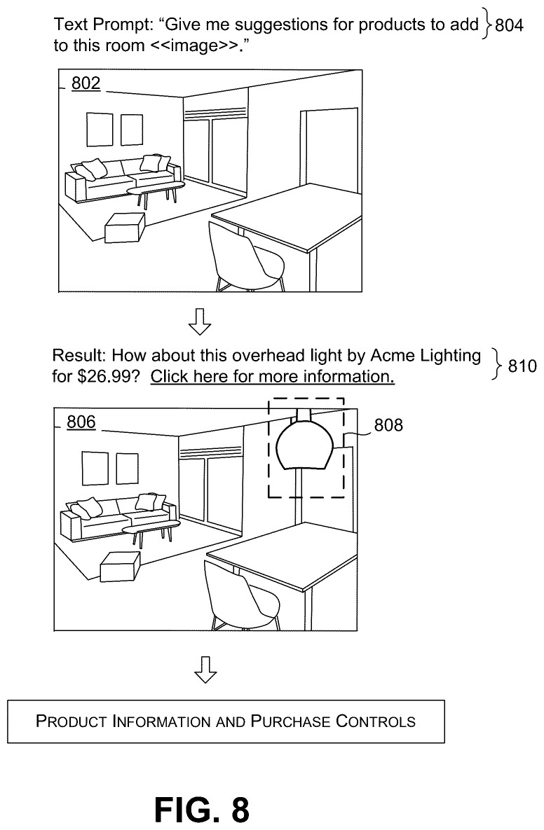

In some examples, in the inference stage, the OSPC 108 performs its analysis without (or independent of) analyzing specific images of candidate foreground images. This is true even for the case in which the OSPC 108 restricts its selection to a predetermined set of object candidates. More specifically, in this case, although the OSPC 108 restricts its viable results to a particular set of candidate objects, the OSPC 108 does not consider the compatibility of any specific image of an object with the input image 106. Rather, the OSPC 202 restricts the range of object possibilities for which it detects probabilities. Stated in yet another way, in the training process, the OSPC 202 learns how to detect the presence of different kinds of objects in background images by processing specific images in the training examples. In the inference stage, this restriction has the effect of limiting the range or “vocabulary” of viable object classes that are considered, but does not involve comparing a specific foreground image with the input image 106. In other examples, the OSPC 108 takes into account example images of candidate objects, which can be provided in the data store 112. As will be described below with reference to FIG. 8, in some examples, the image-synthesizing component 116 also is configurable to create output images based on images of candidate objects that have been selected by the OSPC 108.

One or more application components 114 perform further operations based on the result information supplied by the OSPC 108. For example, an image-synthesizing component 116 generates an output image 118 based on the result information. In the example of FIG. 1, the image-synthesizing component 116 modifies the input image 106 by placing an image of a laptop computer on the tabletop. A display device 120 of any type presents the output image 118. In some implementations, the image-synthesizing component 116 performs its image-generating function using a diffusion model, an example of which is described in Section D.

An image-editing component 122 provides graphical controls by which an end user is able to enter the instruction information and other parameters that govern the behavior of the image-processing system 102, and then view the results of such changes. In some examples, the user interacts with the image-editing component 122 to successively add and remove objects from a scene. An interior designer, for instance, interacts with the image-editing component 122 to receive recommendations about what pieces of furniture to place in a room and where to place them.

A robot control component 124 controls the behavior of a robot of any kind based on the result information. For example, the robot control component 124 instructs a robot to pick up a physical object identified in the result information and place it at a physical location identified in the result information.

A commerce application component 126 leverages the image-processing system 102 to recommend products that are suitable for inclusion in an environment depicted in the input image 106. The commerce application 126 also provides graphical controls that enable the user to retrieve further information about the identified products and to purchase or otherwise select the products.

In some implementations, a training system 128 (which is not part of inference-stage image-processing system 102 itself) trains weights of the machine-trained model 110 used by the OSPC 108, while keeping the weights of the other machine-trained models used by the image-processing system 102 fixed or frozen. In other implementations, the training system 128 trains additional parts of the image-processing system 102 at the same time in end-to-end fashion. Section C provides additional information regarding the operation of the training system 128.

Other implementations vary one or more features of the architecture and/or processes of the image-processing system 102 described above. For example, another implementation invokes the OSPC 108 plural times to perform different analyses. FIG. 1 denotes this feature by a looping arrow 130 associated with the OSPC 108. For example, the image-processing system 102 invokes the OSPC 108 a first time to identify an appropriate object to place in the input image 106. The image-processing system 102 invokes the OSPC 108 a second time to identify an appropriate location to place the object that was identified in the first pass. In other words, the input to the second pass includes the result information generated by the first pass. Another implementation reverses the functions of these two passes. In addition, or alternatively, another implementation invokes the OSPC 108 plural times to identify and place plural respective objects, that is, by identifying and placing a first object in a first pass, identifying and placing a second object in a second pass, and so on. The appropriateness of placing any new object in the input image 106 will depend on the objects that have already been placed, as they form part of the context in which the new object is placed.

Alternatively, or in addition, the image-processing system 102 invokes one or more preliminary analysis components (not shown) to perform preliminary analysis, apart from the analysis subsequently performed by the OSPC 108. For example, one preliminary analysis component identifies objects in the input image 106 using any object-detection approach (such as the YOLO detection model described in Hussan, Muhammad, “YOLOv5, YOLOv8 and YOLOv10: The Go-To Detectors for Real-time Vision,” arXiv, arXiv:2407.02988v1 [cs.CV], Jul. 3, 2024, 12 pages.). Other preliminary analysis components remove noise, identify flat surfaces in the input image 106 above a prescribed size on which new objects could be placed, etc.

Alternatively, or in addition, the image-processing system 102 is adapted to place an object in an input video sequence 132 for examples in which a) the object is specified but the location is not specified, b) the location is specified but the object is not specified, and c) neither the object nor the location are specified. The input video sequence 132 is received from a video camera (not shown) or retrieved from a local or remote data store. The input video sequence 132 includes plural frames.

The OSPC 108 is trained to select the object, if not already specified in the input instructions. The OPSC 108 expresses the object in the result information in any of the ways described above for the standalone image example. In addition, the OSPC 108 generates additional information 134, including a starting frame in which the object will first appear in the input video sequence 132. The additional information 134 also includes a trajectory that defines the object's positions in subsequent video frames in the input video sequence 132. In some examples, the OSPC 108 expresses the trajectory by specifying object bounding boxes in the respective frames included in the trajectory.

In those examples in which an input location is specified, the OSPC constrains its selected trajectory so that, in the starting frame, the object appears at the specified location. An example of an input instruction that would trigger this mode is: “Show a ball that rolls down the hill, starting midway up the hill,” in which “midway up the hill” places a constraint on the starting frame. Alternatively, the OSPC 108 constraints the selected trajectory so that, in all frames in which the object appears, the object is confined to a selected zone. An example of an input instruction that would trigger this behavior is: “Show a ball running down the right side of the road,” in which “right side of the road” specifies a constraint effecting all of the frames in the trajectory.

The image-synthesizing component 116 processes the result information to produce an output video sequence 136 that shows the selected object moving across plural frames. The editing component 122 enables a user to interact with the image-processing system 102 to create and fine-tune the output video sequence 136. Alternatively, the robot control component 124 uses result information to define how to manipulate an object at plural successive instances of time. For example, the robot control component 124 uses the result information to drag a selected physical object across a defined trajectory. Other implementations use the result information in yet other ways.

Among other technical benefits, the image-processing system 102 performs complex analysis of the input image 106 or input video sequence 132 based on underdeveloped instructions. The instructions are underdeveloped or open-ended in the sense that they do not fully describe the specific object to be added to a scene and/or where to place the object. The open-ended and imaginative analysis performed by the image-processing system 102 reduces the manual effort that would otherwise be involved in revising the input image 106. For instance, the analysis performed by the image-processing system 102 reduces the need for a user to engage in painstaking and time-consuming trial-and-error revision of the input image 106 or the input video sequence 132 to achieve a desired outcome. In addition, or alternatively, the image-processing system 102 reduces the ad hoc application of separate tools in revising the input image 106 or the input video sequence 132 and the resources consumed thereby. The image-processing system 102 also produces output images or the video sequences of good quality based on the selection of appropriate objects and the placement of these objects in correct locations in the output images. For instance, the image-processing system 102 reduces visual incongruities due to the placement of objects in inappropriate locations in the output images.

FIG. 2 shows an OSPC 202 (which is a version of the OSPC 108 of FIG. 1) in which the machine-trained model 110 is a language model 204. The language model 204 operates in an auto-regressive manner. Auto-regressive means that tokens are produced token by token, in which each new token that is generated is added to the sequence of input tokens passed to the language model 204 in a next pass. This process continues until the language model 204 generates a stop token. The operation of the OSPC 202 will first be explained in the context of placing objects in standalone images.

An image embedder 206 converts the input image 106 into image embeddings. To perform this task, the image embedder 206 partitions the input image 106 into patches, to produce a partitioned image 208. For example, each patch includes a group of w×h pixels. The image embedder 206 converts the patches into input vectors (e.g., via machine-trained linear projection, multilayer perceptron, or convolutional neural network), and supplements the input vectors with position information. Each position identifies the position of a patch in the input image 106. In some examples, the image embedder 206 then maps the position-supplemented input vectors into image embeddings using a transformer model or some other neural network. An example of a transformer-based visual encoder is described in Dosovitskiy, et al. al., “An Image is Worth 16×16 Words: Transformers for Image Recognition at Scale,” arXiv, arXiv:2010.11929v2 [cs.CV], Jun. 3, 2021, 22 pages.

A text embedder 210 receives instruction information expressed in textual form. This textual information constitutes a user prompt. Although not shown, in some implementations, the OSPC 202 automatically supplies a system prompt that provides more general directives to the image-processing system 102. For example, the system prompt may inform the image-processing system 102 about the general role it is being asked to perform, how it is to interpret the information fed to it, and how it is to format its output results. In other implementations, the system prompt contains the same instructions as the user prompt, eliminating the need for an end user to manually supply the user prompt.

The text embedder 210 first tokenizes the user prompt into a series of text tokens. Each text token is a unit of text having any granularity, such as an individual word, a word fragment produced by byte pair encoding (BPE), a character n-gram, a word fragment identified by the WordPiece or SentencePiece algorithm, etc. The text embedder 210 then maps IDs associated with the sequence of text tokens into respective input vectors, e.g., using a machine-trained linear projection. The text embedder 210 then adds position information (and, in some cases, segment information) to the respective input vectors, to produce position-supplemented input vectors. The position of a position-supplemented input vector describes the position of an associated text token in the input sequence of text tokens. In some examples, the text embedder 210 then maps the position-supplemented input vectors into text embeddings using any type of neural network, such as a transformer model.

In some implementations, the image embedder 206 and the text embedder 210 are trained to produce embeddings in a shared vector space, so that text instances and images that describe similar concepts are placed close together in the vector space, and text instances and images that describe dissimilar concepts are placed farther part. The distance between any text embedding and any image embedding reflects the amount of semantic similarity between a corresponding instance of text and an image. One distance metric for assessing the distance between vectors is cosine similarity. General background information on producing shared-space embeddings is provided in Radford, et al., “Learning Transferable Visual Models From Natural Language Supervision,” Proceedings of the 38th International Conference on Machine Learning, PMLR 139, 2021, 16 pages.

A combining component 212 combines (e.g., concatenates) the image embeddings and text embeddings to produce combined embedding. In some examples, the image embeddings are preceded and followed by segment information that identifies the start and end of the image embeddings.

The language model 204 then auto-regressively maps the combined embeddings to the result information. In doing so, the language model 204 performs attention analysis that examines the relationships among patches in the input image 106. In some examples, the language model 204 is instructed to restrict its consideration of objects to a predefined set of objects. In other examples, no such constraint is placed on the language model 204; here, the language model 204 relies on its priors to recommend new objects.

In other implementations, the OSPC 202 processes the input video sequence 132 that includes plural consecutive frames. In these examples, the image embedder 206 partitions each frame into two-dimensional w×h patches in the same manner described above. In other examples, the image embedder 206 partitions the frames into three-dimensional t×w×h sized patches (referred to as tubelets) that encompass image content from plural frames. In both cases, the image embedder 206 then converts the patches into input vectors, and adds position information to the input vectors to produce position-supplemented input vectors.

The image embedder 206 uses a transformer neural network (or any other type of neural network) to map the position-supplemental input vectors into image embeddings. In performing this task, the image embedder 206 performs attention analysis that involves computing intraframe relationships and interframe relationships. Intraframe relationships define relevance between patches of any given frame, while interframe relationships define relevance between patches in different frames. In some configurations, some layers of a transformer neural network are devoted to determining intraframe relationships, while other layers of the transformer neural network are devoted to determining interframe relationships. General background on the topic of transformer-based video processing can be found in Selva, et al., “Video Transformers: A Survey,” arXiv, arXiv:2201.05991v3 [cs.CV], Feb. 13, 2023, 26 pages, and Arnab, et al., “ViViT: A Video Vision Transformer,” arXiv, arXiv:2103.15691v2 [cs.CV], Nov. 1, 2021, 14 pages. The combining component 212 concatenates the image embeddings with the text embeddings produced by the text embedder 210, to produce combined embeddings.

The language model 204 auto-regressively maps the combined embeddings into result information that specifies a starting frame in which the object first appears in the input video sequence 132 and a trajectory. The trajectory defines the path of the object across frames following the starting frame.

FIG. 3 shows an OSPC 302 (which is a version of the OSPC 108 of FIG. 1) in which the machine-trained model 110 is a classifier model 304. In some implementations, the classifier model 304 includes convolutional neural network layers followed by a classifier head. In other implementations, the classifier model 304 includes a transformer model followed by a classifier head. One example of a transformer model that is capable of performing classification is the BERT model described in Devlin, et al., “BERT: Pre-training of Deep Bidirectional Transformers for Language Understanding,” arXiv, arXiv: 1810.04805v2 [cs.CL], May 24, 2019, 16 pages.

For the case of the standalone input image 106, an input converting component 306 converts the pixels in the input image 106 into input vectors. The classifier model 304 then converts the input vectors into the result information. For example, the classifier model 304 maps the input vectors into hidden state embeddings using convolutional layers, and then determines the most likely object to place at a particular location based on the output embeddings (e.g., using a machine-trained linear transformation of the output embeddings followed by a Softmax operation that implements a normalized exponential function).

In a first mode, supplemental information instructs the classifier model 304 to restrict its analysis to a given region of interest, e.g., defined by a point or bounding box. The classifier model 304 responds by determining the most likely object to place in the region of interest, selected from among a predetermined set of objects in a data store 308. In a second mode, the supplemental information instructs the classifier model 304 to find a location in the input image 106 that is most suitable for placing a given object of interest, which a user may specify using a key input device or voice recognition component. In a third mode, neither a region of interest nor an object of interest is given. The classifier model 304 responds by placing an object that most readily complements the input image 106 at the most suitable location in the input image 106.

FIG. 4 shows further details of how the OSPC 302 performs analysis on the standalone input image 106 in the second and third modes. First consider the second mode, in which the OSPC 302 is tasked with the responsibility of finding the best location to place an identified object. The OSPC 302 moves a n×m window through the input image 106. Or the OSPC 302 is configured to process all of the candidate windows at the same time (e.g., in parallel) by treating these candidate windows as part of the input information. At each location of the window, the classifier model 304 computes a score that expresses the probability of placing the identified object at that location. For instance, the score represents the output of the Softmax operation. It stores these per-location scores in a data store 402. At the end of this process, a max selector 404 identifies the maximum score. If the maximum score is above a prescribed threshold value, then the OSPC 302 identifies the location associated with that score as the best location to place the given object. Note that, in making a decision with respect to any given location, the classifier model 304 takes into account existing content that is present at that location and in the surrounding regions (or in the input image 106 as a whole). This is because a decision about whether to place a new object at a given location depends, in part, on neighboring content already present in the input image 106.

Next consider the third mode, in which neither a given location nor a given object is provided. The OSPC 302 repeats the analysis described above by moving the window across the input image 106 (or by considering all candidate locations at the same time). At each location of the window, the classifier model 304 computes scores for all of the candidate objects, each score identifying the suitability of placing a particular object at the location. At the end of this analysis, the max selector 404 identifies the top N scores that are above a prescribed threshold value, each of which is associated with a particular object and a particular location. The OSPC 302 then presents result information that identifies one or more these objects and their associated locations. Assume that, in the example of FIG. 4, the OSPC 302 concludes that the location X1 is a good place to put a table centerpiece, and that locations X2 and X3 are good places to put chairs.

In another implementation, a first dedicated classifier model selects one or more suitable locations, and a second classifier model selects one or more suitable candidate objects. Alternatively, the first dedicated classifier model selects one or more candidate objects, and the second classifier model selects locations at which to place the objects. In both cases, the results of the first classifier model constrain the choices made by the second classifier model that is invoked.

FIG. 4 is described above in the specific context of a classifier model. But some implementations of the auto-regressive language model OSPC 202 of FIG. 2 also explicitly or implicitly takes into account different candidate regions in an input image when selecting a best location to place a particular object, or selecting both a best location and a most suitable object.

### B. Example Uses of the Image-Processing System

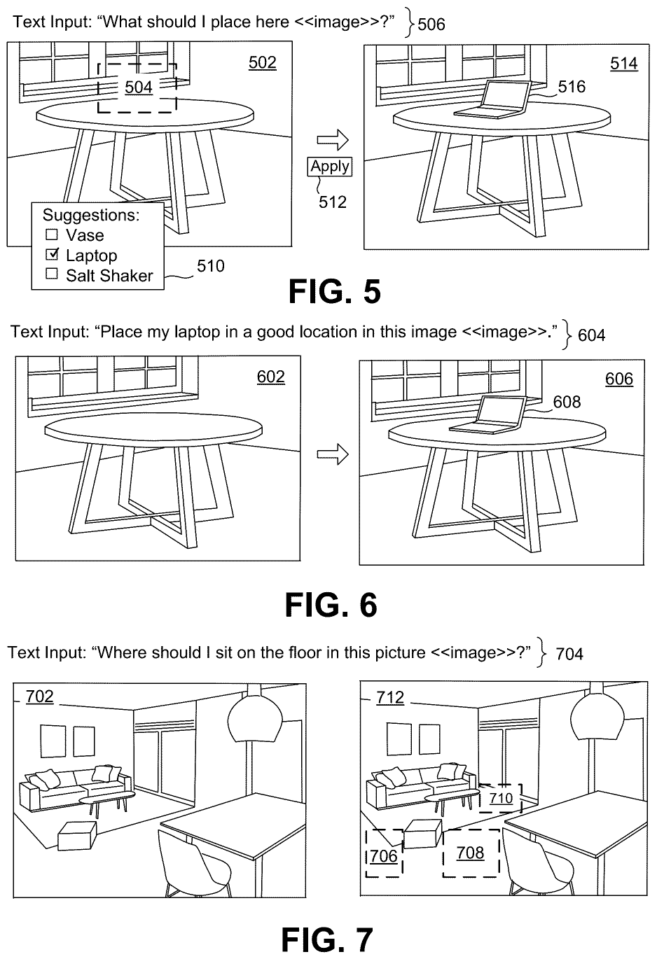

FIGS. 5-10 set forth examples of the image-processing system 102 that use the OSPC 202 of FIG. 2. Here, the supplemental information takes the form of a user prompt, and, in some examples, a specified region. Other examples achieve the same results using the classifier-based implementation of the OSPC 302 of FIG. 3. Here, the supplemental information, if any, takes the form of a selection of an object of interest and/or a region of interest.

Starting with FIG. 5, this figure shows an example in which an input image 502 again shows a room with a table. The image-processing system 102 receives the user's specification of a region in the input image 502 on top of the table, defined by a bounding box 504. The image-processing system 102 also receives the user's specification of a text prompt 506, posing the question “What should I place here?” Assume that the OSPC 108 processes the input information to propose three objects in a user interface panel 510. Assume that the image-processing system 102 receives the user's selection of the laptop computer, followed by the user's selection of an apply instruction 512. The image-processing system 102 then displays an output image 514 that shows a laptop computer 516 placed on the tabletop.

FIG. 6 shows an example in which an input image 602 again shows a room with a table. The image-processing system 102 receives the user's specification of a text prompt 604, presenting the directive, “Place my laptop in a good location.” That is, whereas the example of FIG. 5 specifies the desired location but not what object should be placed there, the example of FIG. 6 specifies the object but not its location. Assume that the OSPC 108 processes the input information to choose the tabletop as the location at which to place the laptop computer. An output image 606 shows a laptop computer 608 on top of the table.

FIG. 7 shows an example that is a variant of the example of FIG. 6. Here, an input image 702 shows a picture of a living room and the text input 704 poses the question, “Where should I sit on the floor?” Here, the category of the object is implicitly a human being. The OSPC 108 identifies three candidate locations (706, 708, 710). An output image 712 presents bounding boxes that show these candidate locations (706, 708, 710).

FIG. 8 shows an example of an application for selecting items that incorporates the use of the image-processing system 102. For example, the application is accessible via a shopping-related website. Here, an input image 802 again shows a picture of a living room. The text prompt 804 reads, “Give me suggestions for products to add to this room.” The OSPC 108 chooses a particular class of products (e.g., an overhead lamp) from a database of available actual items, and selects a good location to place the product (for instance, by placing the lamp over the table). An output image 806 illustrates these selections by showing a lamp 808 above the table. That is, the OSPC 108 chooses the general category of “ceiling light.” In a first implementation, the image-synthesizing component 116 synthesizes a lamp in the output image 806 based on the category “ceiling light” alone. At the request the user, the application then presents images of actual lamps from the database that are similar to the synthesized lamp. In a second implementation, the OSPC 108 directly retrieves an image of a particular lamp from the database of available items, and then creates the output image 806 that includes the particular lamp. A message 810 invites the user to explore additional information about the particular lamp. Activating a link associated with the message 810 causes the application to display the product information, which it retrieves from the database of available products. Although not shown, in the second implementation, the application presents a graphical prompt by which the user can instruct the image-sensitizing component 116 to replace the particular lamp with an image of another lamp selected from the database of available items. In both the first and second implementations, the application also provides a graphical prompt by which the user is able to purchase or otherwise select the lamp 808. In other examples (not shown), the OSPC 108 chooses plural kinds of items from the database of available items, such as a lamp, vase, and a clock.

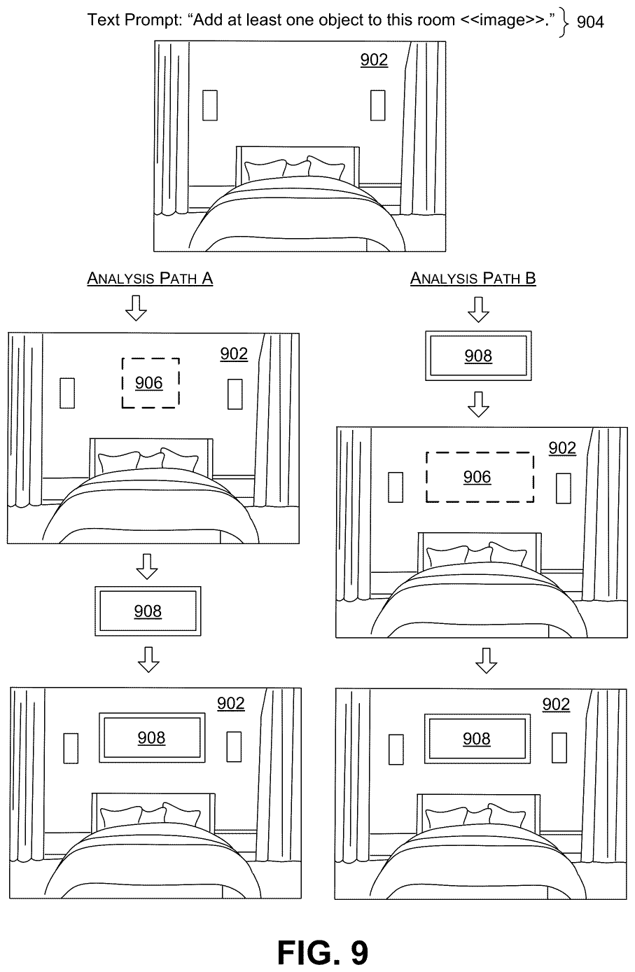

FIG. 9 shows two ways that the OSPC 108 is capable of identifying an object and its location, given an input image 902 and an open-ended text prompt 904 that generally requests the image-processing system 102 to place one or more objects in the input image 902. That is, in a first analysis path (A), the OSPC 108 identifies a location 906 at which to place an object and then identifies an object 908 to place at that location 906. Here, the object 908 is a picture to be hung on a wall. In a second analysis path (B), the OSPC 108 first identifies the object 908 and then identifies the location 906 at which to place the object 908. The OSPC 108 may be instructed to take one of these paths based on the specific instructions in the user prompt and/or the specific instructions in the system prompt. In other cases, the OSPC 108 is trained or otherwise preconfigured to perform a sequence of analysis steps in a particular order. In other cases, the path that the OSPC 108 takes is opaque to the end user, and arises from the complex patterns detected by the training system 128 during the training of the OSPC 108.

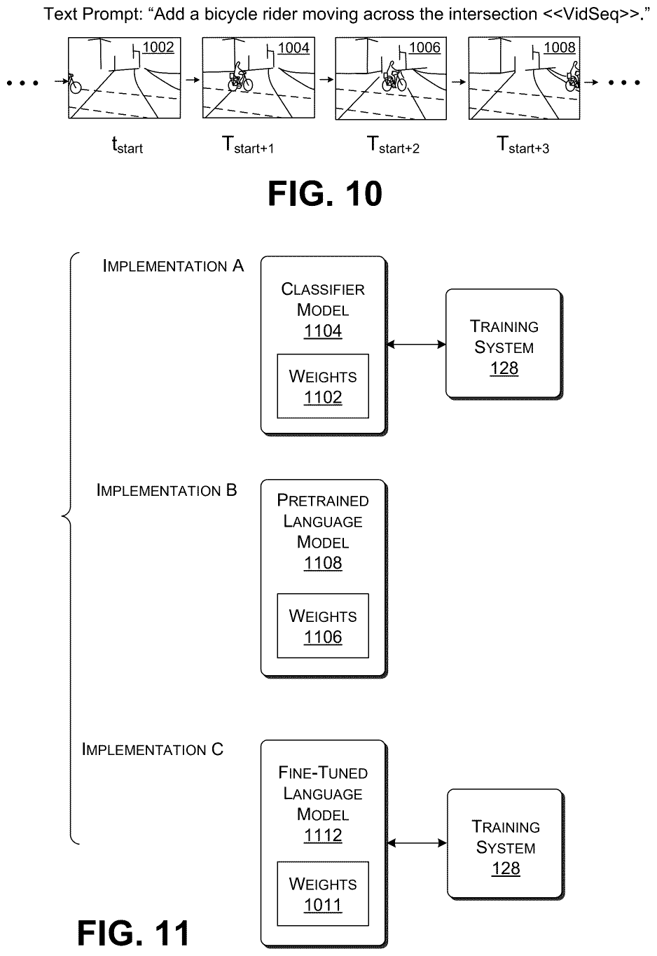

FIG. 10 shows an example in which an input video sequence shows a road intersection in a city. The text input provides the instruction: “Add a bicycle rider moving across the intersection.” In this example, the input instruction explicitly identifies the desired object to be added to the input video sequence. The language model 204 responds by choosing a starting frame 1002 at which the bicycle rider first appears, and a trajectory that defines the positions of the bicycle rider across subsequent frames (1004, 1006, 1008). The training applied to the language model 204 governs the “choices” that it makes, rather than discrete rules. Assume that the weights of the language model 204 express the cumulative insight that a good time to progress across an intersection is when a traffic light turns green and/or when there is no oncoming traffic. Similarly, the weights of the language model 204 capture the way riders typically move across intersections of the kind shown in the input video sequence. The user can further constrain the selection of the starting frame and/or trajectory by specifying the starting condition with greater detail, or the path to be taken with greater detail. For example, a variation of the above input instruction specifies that the rider should start when the light turns green, and/or the rider's path should be restricted to a bicycle lane.

### C. Training the Image-Processing System

FIG. 11 shows three different ways of training the OSPC 108 of FIG. 1. This figure is explained in the context of training the OSPC 108 to process standalone images, but the same principles are applicable to the task of training the OSPC 108 to process video sequences. In a first implementation, the training system 128 uses supervised training to train the weights 1102 of a classifier model 1104. Once trained, the classifier model 1104 transforms input information into an object identifier that identifies an object category or a category of objects, and/or one or more suitable locations.

In a second implementation, the training system 128 relies on the existing pretrained weights 1106 of a pretrained language model 1108 to implement the OSPC 108. In other words, the second implementation relies on the priors of the pretrained language model 1108. The pretrained language model 1108 transforms the input combined embeddings into result information that identifies each object to be placed and the location at which it should be placed.

A pretraining system (not shown) produces the pretrained language model 1108 based on any training objective. For example, the pretraining system pretrains a generative language model by performing unsupervised training using language modeling (e.g., predicting the next word in a given text passage and comparing the prediction with the actual next word) and by performing supervised training (e.g., predicting an output result and comparing the prediction with a ground-truth result). Background on the general task of pretraining generative language models is provided in Radford, et al., “Improving Language Understanding by Generative Pre-training,” OpenAI, San Francisco California, Jun. 11, 2018, 12 pages. One example of a publicly available pre-trained language model is described in Touvron, et al., “LLaMA: Open and Efficient Foundation Language Models,” arXiv, arXiv:2302.13971v1 [cs.CL], Feb. 27, 2023, 27 pages. Another example of a publicly available pretrained language model is described in Abdin, et al., “Phi-3 Technical Report: A Highly Capable Language Model Locally on Your Phone,” arXiv, arXiv:2404.14219v4 [cs.CL], Aug. 30, 2024, 24 pages.

In a third implementation, the training system 128 uses supervised training to train the weights of a pretrained language model, to produce the modified weights 1110 of a fine-tuned language model 1112. This training effectively adapts the pretrained language model to the specialized task of object selection and location determination. Once trained, the fine-tuned language model 1112 transforms the input combined embeddings into result information that identifies the object to be placed and the location at which it should be placed.

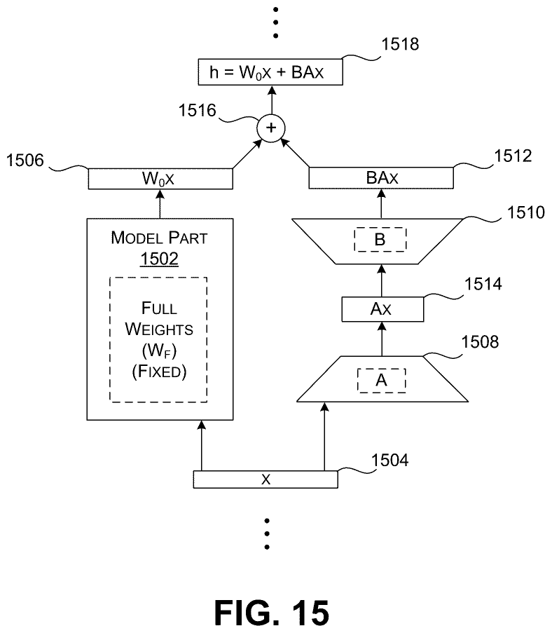

In some implementations, the training system 128 performs fine-tuning by adjusting all of the weights of the pretrained model. In other implementations, the training system 128 leaves the weights of the pretrained model intact (that is, fixed), and trains another set of modification weights. Once trained, the behavior of the resultant fine-tuned trained language model 1112 is governed by a combination of the original weights of the pretrained model and the modification weights. One approach for training modification weights is explained below in the context of the description of FIG. 15. Background information on the general topic of matrix decomposition in a training operation can found at Hu, at al., “LoRA: Low-Rank Adaptation of Large Language Models,” arXiv, arXiv:2106.09685v2 [cs.CL], Oct. 16, 2021, 26 pages.

In another approach, the training system 128 adds one or more additional layers to the pretrained model, each layer being referred to as an adapter. For example, each adapter is a fully connected neural network placed on top of a component of the pretrained language model. The training system 128 then trains the weights of the adapter(s), while holding the weights of the pretrained model part fixed. General background information on the use of adapters can be found in: Houlsby, et al., “Parameter-Efficient Transfer Learning for NLP,” arXiv, arXiv:1902.00751v2 [cs.LG], June 2019, 13 pages. The process of training modification weights is more resource efficient than training the full set of original weights.

The fine-tuned model 1112 exhibits the best performance. For example, in one study, the fine-tuned model 1112 predicts the identity of a missing object (that has been removed by inpainting) 73 percent of the time. The classifier model 1104 has an accuracy of 53 percent, while the pretrained language model 1108 (with no finetuning) has an accuracy of 19 percent.

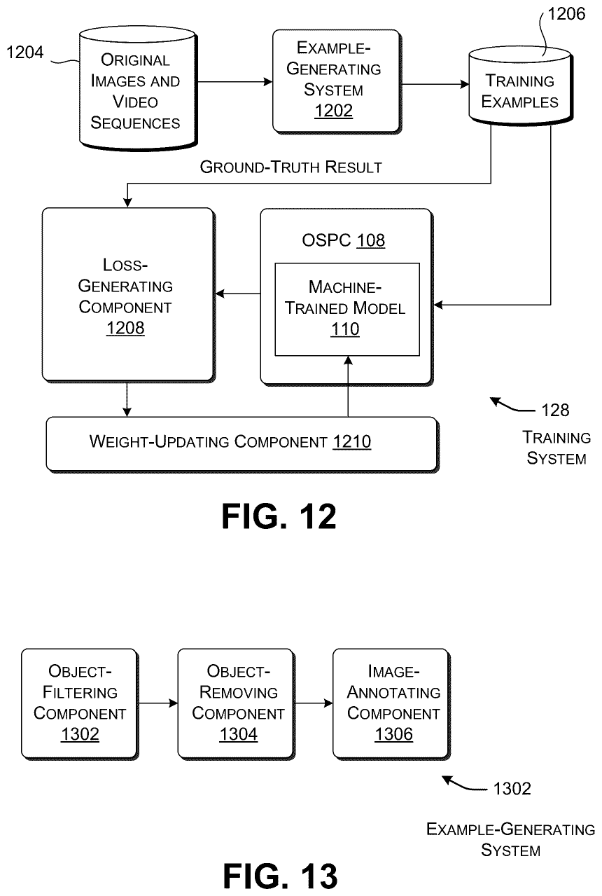

FIG. 12 shows one implementation of the training system 128 for use in the context of training of the OSPC 108 for either the first or third implementations of FIG. 7. Again, the training system 128 is first explained for the case of placing objects in standalone images. In a first phase, an example-generating system 1202 produces a set of training examples based on a set of original images. A data store 1204 stores the original images and a data store 1206 stores the training examples. The example-generating system 1202 produces each training example by removing an object from an original image and annotating the thus-modified image with object information that identifies the object that has been removed and location information that identifies the location of the object in the original image. The object information and location information constitute ground-truth result information for this training example.

For training the language model 204 in the implementation of FIG. 2, each training example is also coupled with a textual input instruction, which the training system 128 selects from a predefined list of template instructions. The input instruction defines the task that the language model 204 is asked to perform. One such task is adding a specified object to an appropriate location in a test image. Another task is selecting an appropriate object to add to a specified location in a test image. Another task is selecting both the object and its location.

In some examples, the original images in the data store 1204 are provided by the publicly available COCO (Common Objects in Context) dataset. The objects in this dataset are annotated with bounding boxes and object information that identifies the objects. In other examples, the original images are produced by using any object detection technique, such as the YOLO technique.

In a second phase, the training system 128 uses the machine-trained model 110 of the OSPC 108 to produce model-generated result information for each modified image in the training example. A loss-generating component 1208 determines the difference between the model-generated result information and the ground-truth result information for this training example using any loss function, such as cross entropy. Overall, the training system 128 performs this operation for a batch of training examples to produce loss information. A weight-updating component 1210 adjusts the weights of the machine-trained model 110 of the OSPC 108 based on the difference information, e.g., using stochastic gradient descent in combination with back propagation.

The training system 128 performs training that includes plural training tasks. A first training task involves predicting an object to place at a specified location in a test image, and then comparing the model-predicted object with the ground-truth object. A second training task involves predicting a location in the test image to place a specified object, and then comparing the model-predicted location to the ground-truth location. It is not necessary to specifically train for a task that involves predicting both an object and its location, then comparing the model-predicted object and model-predicted location with the counterpart ground-truth object and ground-truth location. This is because such a task involves considering what object is most appropriate for each candidate location defined by a bounding box, which is learned based on the first training task. However, it is also possible to separately and explicitly train for this task.

In some examples, the training system 128 is guided to perform a particular training task based on text-based input instructions given to the training system 128. For example, with respect to the first training task, an input instruction may include the text: “Choose an appropriate object to place at this location <bounding box>,” where “bounding box” identifies the location of a bounding box in the test image. With respect to the second training task, an input instruction may read: “Choose an appropriate location at which to place this <object>,” where “object” refers to the category of objects to be placed in the test image. An input instruction for the third training task specifies neither the object nor its location.

FIG. 13 shows one implementation of the example-generating system 1202 of FIG. 12. An object-filtering component 1302 identifies objects from the original images that are too either big or too small. More formally, the object-filtering component 1302 identifies objects from the original images that have a size that is either above a prescribed upper-bound threshold value or below a lower-bound threshold value.

An object-removing component 1304 removes the identified objects, e.g., masking out the identified objects and then reconstructing an input image without the presence of the masked-out object via inpainting. An image produced by masking replaces an identified object with mask pixels have default values. One tool for performing inpainting is a diffusion model, an example of which is set forth in Section D.

An image-annotating component 1306 annotates the modified image produced by the object-removing component 1304 with ground-truth result information. As noted above, this result information provides the identity of the object that has been removed and its location in the original image.

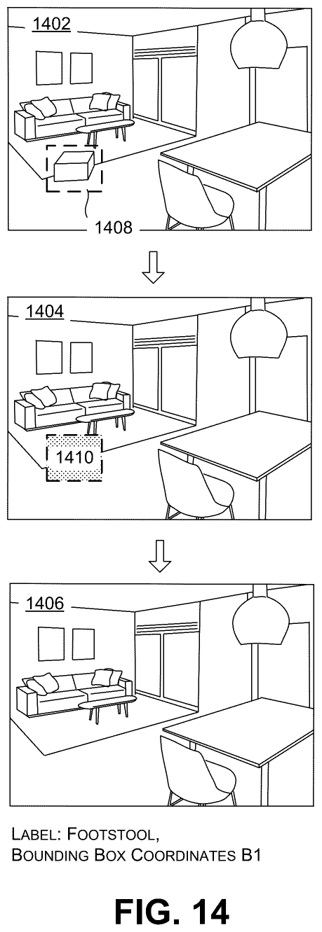

FIG. 14 shows an example of the operation of the example-generating system 1102, which involves transforming an original image 1402 into a masked image 1404, and then a reconstructed image 1406. Assume that the object-filtering component 1302 identifies a footstool 1408, among other objects in the original image 1402. The object-removing component 1304 produces the masked image 1404 in which the footstool 1408 is masked out with a mask 1410, and then produces the reconstructed image 1406 in which the scene is recreated without the presence of the footstool 1408. The image-annotating component 1306 then adds ground-truth result information that identifies the object that has been removed and its location.

The training system 128 performs additional training operations for those implementations that are capable of adding objects to input video sequences. The data store 1204 stores the input video sequences. In a first phase, the example-generating system 1202 identifies objects within a specified range of sizes that move across the frames of the input video sequences, and then removes these objects in the same manner described above. This yields reconstructed video sequences.

In a second phase, the training system 128 uses the machine-trained model 110 (e.g., the language model 204 of FIG. 2) to transform each reconstructed video sequence into result information. The result information includes a model-generated starting frame and a model-generated trajectory. The loss-generating component 1208 then generates a loss measure, e.g., using cross entropy, that expresses the differences between model-generated starting frames and the ground-truth starting frames, and the differences between the model-generated trajectories and the ground-truth trajectories. The weight-updating component 1210 updates the weights 110 of the OSPC 118 based on a loss measure that reflects the extent to which the model-generated result information agrees with the ground-truth starting frames and ground-truth trajectories.

FIG. 15 shows one approach for fine-tuning weights of a model part 1502 of a pretrained language model, e.g., corresponding to the third implementation shown in FIG. 10. The model part 1502 may refer to one or more layers of the pretrained language model that perform a particular function. A left-most path of FIG. 15 shows a forward pass by which the model part 1502 maps an input embedding information (x) 1504 to an output embedding information 1506. The model part 1502 performs this task by multiplying the input embedding information by a base portion (W_{F}) of fixed weights, to produce the output embedding information 1506 defined by W_{F}x. A right-most path of the FIG. 15 shows a forward pass in which two feed-forward layers (1508, 1510) map the input embedding information 1504 to output embedding information 1512. More specifically, the first feed-forward layer 1508 multiplies the input embedding information 1504 by a first weight matrix A, to produce intermediate embedding information 1514 having a value Ax. The weight matrix A is randomly initialized at the start of a training operation. The second feed-forward layer 1510 multiples a second weight matrix B by the intermediate embedding information 1514, to produce the final output embedding information 1512 given by BAx. The weight matrix B is set to zero at the beginning of the training operation. A summation component 1516 adds the output embedding information 1506 produced by left-most path with the output embedding information 1512 produced by the right-most path, to produce a combined output embedding 1518 given by h=W_{F}x+ABx. The training system 128 performs this same process for subsequent layers of the pretrained model to produce a final model-generated result, which is then compared with a ground-truth result. At the end of the training, the training system 128 adds the weights associated with the two paths together, to provide a refined-weight counterpart of the original pretrained model.

In some implementations, the weight matrix W_{F} has dimensions of d×k, while the weight matrix A has the dimensions of r×k and the matrix B has the dimensions of d×r. The multiplication of matrix A by matrix B therefore yields a matrix having the same size as the matrix W_{F}. The symbol r refers to the rank. Rank r is typically much smaller than d or k (e.g., r<<min (d, k)). As such, there are much fewer weights to learn in the matrices A and B compared to the weights in the base matrix W_{F}.

### D. Example of Machine-Trained Models

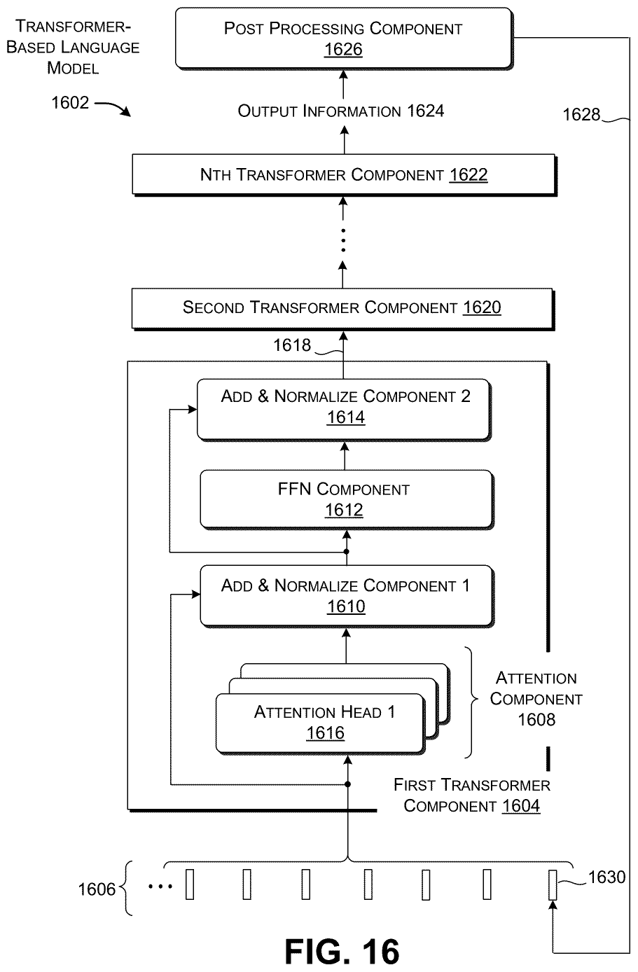

FIG. 16 shows a transformer-based language model (“language model”) 1602 for implementing OSPC 108 of FIG. 1, according to the implementation of FIG. 2. The language model 1602 is composed, in part, of a pipeline of transformer components, including a first transformer component 1604. FIG. 16 provides details regarding one way to implement the first transformer component 1604. Although not specifically illustrated, other transformer components of the language model 1602 have the same architecture and perform the same functions as the first transformer component 1604 (but are governed by separate sets of weights).

The language model 1602 commences its operation with the receipt of the combined embeddings 1606 provided by the combining component 212. The first transformer component 1604 operates on the combined embeddings 1606. In some implementations, the first transformer component 1604 includes, in order, an attention component 1608, a first add-and-normalize component 1610, a feed-forward neural network (FFN) component 1612, and a second add-and-normalize component 1614.

The attention component 1608 determines how much emphasis should be placed on parts of input information when interpreting other parts of the input information. Consider, for example, a sentence that reads: “I asked the professor a question, but he could not answer it.” When interpreting the word “it,” the attention component 1608 will determine how much weight or emphasis should be placed on each of the words of the sentence. The attention component 1608 will find that the word “question” is most significant.

The attention component 1608 performs attention analysis using the following equation:

$$Attention ( Q , K , V ) = softmax ( \frac{Q {K}^{T}}{\sqrt{{d}_{k}}} ) V . \qquad ( 1 )$$

The attention component 1608 produces query information Q by generating the product of the combined embeddings 1606 and a query weighting matrix W^{Q}. Similarly, the attention component 1608 produces key information K and value information V by generating the product of the combined embeddings 1606 and a key weighting matrix W^{K} and a value weighting matrix W^{V}, respectively. To execute Equation (1), the attention component 1608 takes the dot product of Q with the transpose of K, and then divides the dot product by a scaling factor \sqrt{d}, to produce a scaled result. The symbol d represents the dimensionality of Q and K. The attention component 1608 takes the Softmax (normalized exponential function) of the scaled result, and then multiplies the result of the Softmax operation by V, to produce attention output information. In some cases, the attention component 1608 is said to perform masked attention insofar as the attention component 1608 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 16 shows that the attention component 1608 is composed of plural attention heads, including a representative attention head 1616. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1608 concatenates the output results of the attention component's separate attention heads, and then multiplies the results of this concatenation by another weight matrix W°.

The add-and-normalize component 1610 includes a residual connection that combines (e.g., sums) input information fed to the attention component 1608 with the output information generated by the attention component 1608. The add-and-normalize component 1610 then normalizes the output information generated by the residual connection, e.g., by layer-normalizing values in the output information based on the mean and standard deviation of those values, or by performing root-mean-squared normalization. The other add-and-normalize component 1614 performs the same functions as the first-mentioned add-and-normalize component 1610. The FFN component 1612 transforms input information to output information using a feed-forward neural network having any number of layers.

The first transformer component 1604 produces output information 1618. A series of other transformer components (1620, . . . , 1622) perform the same functions as the first transformer component 1604, each operating on output information produced by its immediately preceding transformer component. Each transformer component uses its own level-specific set of machine-trained weights. The final transformer component 1622 in the language model 1602 produces final output information 1624.

In some implementations, a post-processing component 1626 performs post-processing operations on the final output information 1624. For example, the post-processing component 1626 performs a machine-trained linear transformation on the final output information 1624, and processes the results of this transformation using a Softmax component (not shown). The language model 1602 uses the output of the post-processing component 1626 to predict the next token in the input sequence of tokens. In some applications, the language model 1602 performs this task using a greedy selection approach (e.g., by selecting the token having the highest probability), or by using the beam search algorithm (e.g., by traversing a tree that expresses a search space of candidate next tokens).

In some implementations, the language model 1602 operates in an auto-regressive manner, as indicated by the loop 1628. To operate in this way, the language model 1602 appends a predicted token to the end of the sequence of input tokens, to provide an updated sequence of tokens. The predicted token leads to the production of a new embedding 1630. In a next pass, the language model 1602 processes the updated sequence of combined embeddings to generate a next predicted token. The language model 1602 repeats the above process until it generates a specified stop token

The above-described implementation of the language model 1602 relies on a decoder-only architecture. Other implementations of the language model 1602 use an encoder-decoder transformer-based architecture. Here, a transformer-based decoder receives encoder output information produced by a transformer-based encoder, together with decoder input information.

In other implementations, the post-processing component 1626 represents a classification component that produces a classification result. In some implementations, the classification component is implemented by using a fully connected feed-forward neural network having one or more layers followed by a Softmax component. A BERT-based transformer model is an example of this configuration.

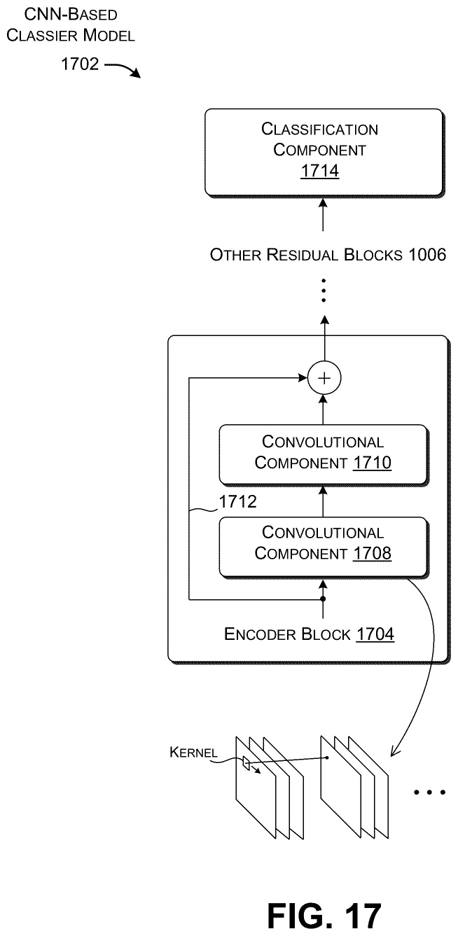

FIG. 17 shows another implementation of the OSPC 108 that uses a classifier model 1702 to determine what object should be added to an input image and/or where it should be placed. The classifier model 1702 includes a pipeline that provides plural encoder blocks (e.g., encoder blocks 1704, 1706) optionally interspersed with pooling components, not shown). FIG. 17 specifically shows the merely illustrative case in which the representative encoder block 1704 includes a pair of convolutional components (1708, 1710). FIG. 17 also shows an optional residual connection 1712 that adds input information fed to the first convolutional component 1708 to output information produced by the second convolutional component 1710. One example of this kind of convolutional neural network is the ResNet50 model.

Each convolutional component performs a convolution operation that involves moving an n×m kernel across feature information supplied to the convolutional component. At each position of the kernel, the convolutional component generates the dot product of the kernel values with the underlying values of the feature information. The bottom of FIG. 17 represents this convolution operation in high-level form. Each pooling component (not shown) down-samples results of a preceding convolutional operation using some sampling function, such as, for example, a maximum operation that selects a maximum value within a subset of values.

A classification component 1714 maps logits produced by a last encoder block 1706 to an output classification. In some implementations, the classification component 1714 is implemented by a feed-forward neural network of any type in combination with a Softmax component.

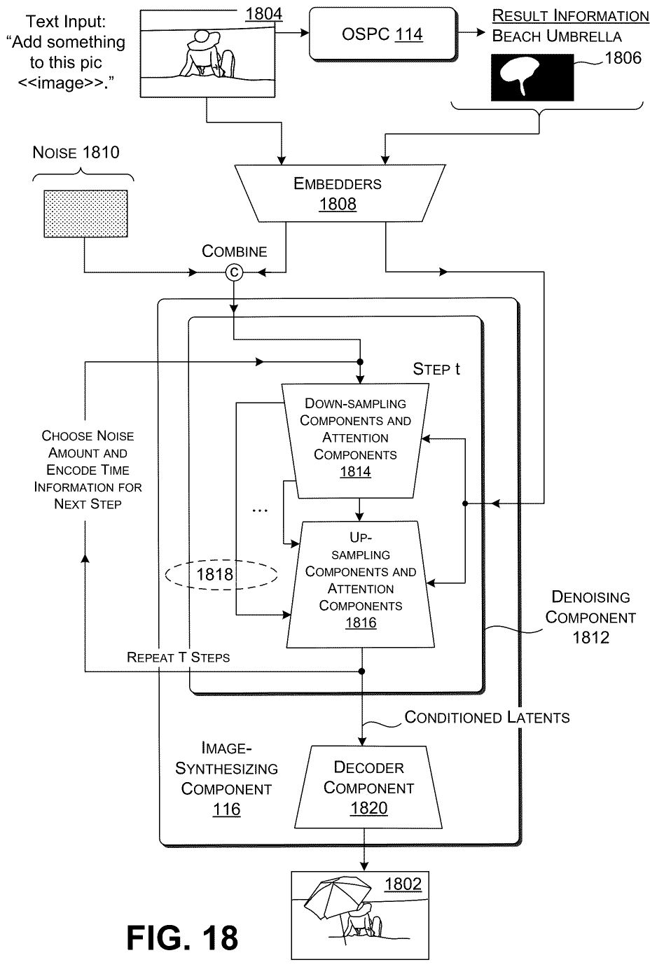

FIG. 18 shows one implementation of the image-synthesizing component 116 of FIG. 1. For the example of single-image transformation, the image-synthesizing component 116 synthesizes an output image 1802 based on the input image 1804 and the result information provided by the OSPC 108. Assume that the OSPC 108 is asked to generate the result information that identifies the best location to place any suitable object in the input image 1804. For example, for a language model implementation, the OSPC 108 responds to a text prompt that reads, “Add something to this pic.” The result information includes a description of each object to be added to an input image 1804 and the location at which to add the object. In the example of FIG. 18, the object is a beach umbrella, and the location is specified by a mask 1806. In other examples, the location is specified by coordinates, a bounding box, a verbal description, etc. All of these location-specifying expressions indicate that the beach umbrella is to be placed directly in back of the person on the beach. The OSPC 108 may have reached this “conclusion” based on a common location at which beach umbrellas are positioned relative to people who are facing a body of water, as evidenced in the training images. The shadows cast in the training images may also influence the placement of the beach umbrellas.

Now referring to the specific features of FIG. 18, in some implementations, the result information is already in the form of embeddings. Likewise, the image embeddings have already been generated by the image embedder 206 shown in FIG. 2. In other implementations, the original image and/or the result information are not in the form expected by the image-synthesizing component 116. For those implementations, one or more embedders 1808 transform the input image 1804 and the result information into image embeddings and result information embeddings. In some implementations, each embedder is an encoder of a variation autoencoder. The image-synthesizing component 116 also receives input noise 1810, which constitutes latent seed information. The image-processing system 102 combines the noise 1810 with the image embeddings, to produce noisy image embeddings.

A denoising component 1812 operates on the noisy image embeddings in a series of T steps. In each step, the denoising component 1812 identifies and removes some noise from the noisy image embeddings. The amounts of noise removed in different steps are not the same and is governed by a schedule. The processing performed by each step is also conditioned by the result information, including the identity of the object to be added to the input image 1804 and its location.

In some implementations, a U-Net neural network performs each step of the denoising process. The U-Net neural network includes a series of down-sampling components 1814 followed by a series of up-sampling components 1816. Each down-sampling component decreases the size of the image information fed to it, and each up-sampling component increases the size of the image information fed to it. Skip connections 1818 connect information provided by different layers of the down-sampling components 1814 to associated levels of the up-sampling components 1816. In some implementations, each of the down-sampling components 1814 and up-sampling components 1816 are implemented by convolutional neural networks. The convolutional neural networks are interspersed with attention components that performs cross-attention, guided by the result information embeddings that identify the object to be added to the input image 1804 and its location.

A decoder component 1820 converts the latent-space output embeddings produced by the denoising component 412 into the output image 1802. In some implementations, the decoder component 1820 is a decoder of a variational autoencoder.

More generally, the kind of diffusion model shown in FIG. 18 operates in the latent space because the information that it processes has been first converted to a lower dimensioned embedding space. Other kinds of diffusion models operate in the pixel space. A publicly available diffusion model that operates in the latent space is provided by STABILITY AI of London, England, which is also described in Rombach, et al., “High-Resolution Image Synthesis with Latent Diffusion Models,” arXiv, arXiv:2112.10752v2 [cs.CV], Apr. 13, 2022, 45 pages.

While the above explanation was framed in the context of processing standalone input images, the same principles are applicable to synthesizing the frames of output video sequences. For each frame, the image-synthesizing component 116 carries out instructions to add a particular kind of object at a particular location in an output frame.

The training of a diffusion model involves a forward diffusion process and a reverse diffusion process. In the forward diffusion process, a training system adds Gaussian noise to images in a succession of steps (e.g., 50 to 100 steps in some examples). A schedule governs how much noise is added in each step. In the reverse diffusion process, the training system predicts the amount of noise in image content in a succession of steps and removes that predicted noise over the succession of steps. Both the forward diffusion process and the reverse diffusion process are Markov chains, in which each state solely depends on its previous state. Training involves, for individual steps, computing the differences between the predicted amounts of noise computed in the reverse process and the actual amounts of noise added in the forward diffusion process, and adjusting the weights of the diffusion model to improve the diffusion model's subsequent ability to predict noise. Through this process, the diffusion process learns how to reconstruct meaningful image content, given an input image containing random noise.

For the video-generating applications, the image-processing system 102 can use a video diffusion model trained by others. These types of video diffusion models are trained, in part, to achieve temporal consistency among the frames of the generated video sequence. In other examples, the image-processing system 102 adapts an image diffusion model trained by others for use in generating videos. There are different ways of ensuring temporal consistency in the inference stage among generated frames for this kind of model, such as the FLATTEN technique described in Cong, et al., FLATTEN: optical FLow-guided ATTENtion for consistent text-to-video editing,” arXiv, arXiv:2310.05922v3 [cs.CV], Feb. 29, 2024, 21 pages.

While different types of diffusion models are described above, other implementations of the image-synthesizing component 116 use other generated machine-training technology besides diffusion models, such as generative adversarial networks (GANs).

### E. Illustrative Processes

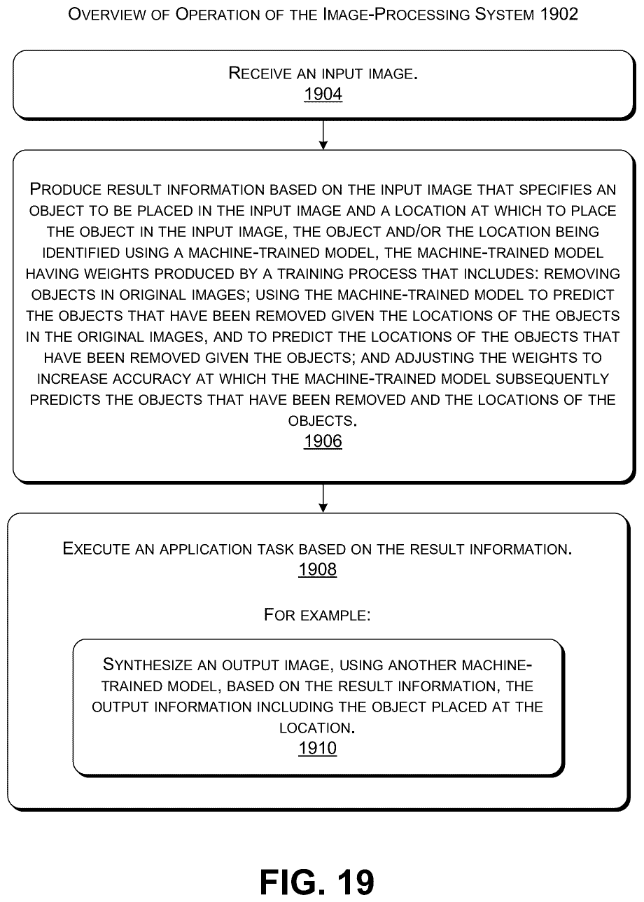

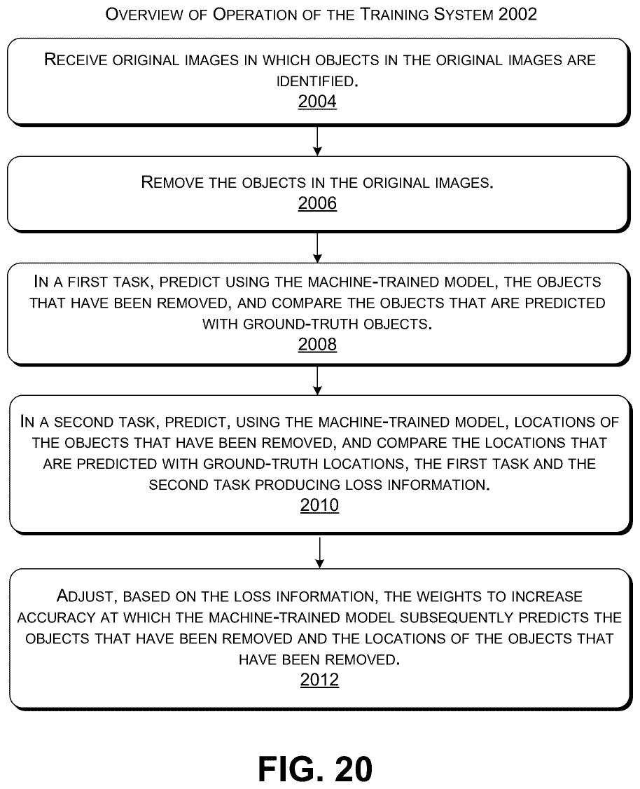

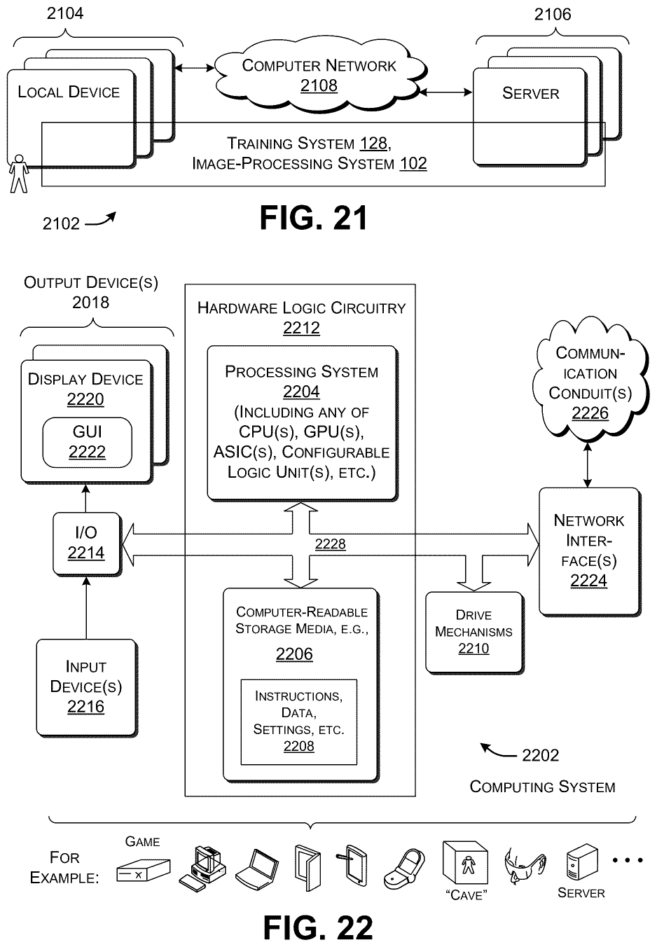

FIGS. 19 and 20 show two processes that represent an overview of the operation of the image-processing system 102 and training system 128 of FIGS. 1 and 11, respectively. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 21 and 22.

More specifically, FIG. 19 shows a process 1902 for supplementing an input image (e.g., the input image 106). In block 1904, the image-processing system 102 receives the input image. In block 1906, the image-processing system 102 produces result information based on the input image that specifies an object to be placed in the input image and a location at which to place the object in the input image, the object and/or the location being identified using a machine-trained model (e.g., the machine-trained model 110). In some examples, the producing is performed independently of an image of the object. In block 1908, the image-processing system 102 executes a computer-implemented application task based on the result information.

The machine-trained model has weights produced by a training process that includes: removing objects in original images; using the machine-trained model to predict the objects that have been removed given the locations of the objects in the original images, and to predict the locations of the objects that have been removed given the objects; and adjusting the weights to increase accuracy at which the machine-trained model subsequently predicts the objects that have been removed and the locations of the objects. The training process iteratively repeats the prediction and adjusting operations.

In some implementations, the application task in block 1908 involves synthesizing an output image, using another machine-trained model, based on the result information. The output information includes the object placed at the location.

In some implementations, the producing of block 1906 includes a first mode in which the machine-trained model identifies the object based on input that specifies the location, a second mode in which the machine-trained model identifies the location based on input that specifies the object, and a third mode in which the machine-trained model identifies both the object and the location,

FIG. 20 shows a process 2002 for training weights of a machine-trained model (e.g., the machine-trained model 110) of the image-processing system 102. In block 2004, the training system 128 receives original images in which objects in the original images are identified. In block 2006, the training system 128 removes the objects in the original images. In block 2008, in a first task, the training system 128 predicts, using the machine-trained model, the objects that have been removed, and compares the objects that are predicted with ground-truth objects. In block 2010, in a second task, the training system 128 predicts, using the machine-trained model, locations of the objects that have been removed, and compares the locations that are predicted with ground-truth locations. The first task and the second task produce loss information. In block 2012, the training system 128 adjusts, using the loss information, the weights to increase accuracy at which the machine-trained model subsequently predicts the objects that have been removed and the locations of the objects that have been removed.

### F. Illustrative Computing Systems

FIG. 21 shows computing equipment 2102 that, in some implementations, is used to implement the image-processing system 102 and the training system 128. The computing equipment 2102 includes a set of local devices 2104 coupled to a set of servers 2106 via a computer network 2108. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 2108 is implemented as a local area network, a wide area network (e.g., the Internet), one or more point-to-point links, or any combination thereof.

The bottom-most overlapping box in FIG. 21 indicates that the functionality of the image-processing system 102 and the training system 128 are capable of being spread across the local devices 2104 and/or the servers 2106 in any manner. In one example, the image-processing system 102 is entirely implemented by a local device. In another example, the functions of the image-processing system 102 are entirely implemented by the servers 2106. Here, a user is able to interact with the servers 2106 via a browser application running on a local device. In other examples, some of the functions of the image-processing system 102 are implemented by a local device, and other functions of the image-processing system 102 are implemented by the servers 2106. In some implementations, for instance, the OSPC 108 is implemented by the servers 2106, and the remainder of the functions of the image-processing system 102 are implemented by each local device. The training system 128 can likewise be implemented by the servers 2106, the local devices 2104, and/or a combination of the servers 2106 and the local devices 2104.

FIG. 22 shows a computing system 2202 that, in some implementations, is used to implement any aspect of the mechanisms set forth in the above-described figures. For instance, in some implementations, the type of computing system 2202 shown in FIG. 22 is used to implement any local computing device or any server shown in FIG. 21. In all cases, the computing system 2202 represents a physical and tangible processing mechanism.

The computing system 2202 includes a processing system 2204 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 2202 also includes computer-readable storage media 2206, corresponding to one or more computer-readable media hardware units. The computer-readable storage media 2206 retains any kind of information 2208, such as machine-readable instructions, settings, model weights, and/or other data. In some implementations, the computer-readable storage media 2206 includes one or more solid-state devices, one or more hard disks, one or more optical disks, etc. Any instance of the computer-readable storage media 2206 represents a fixed or removable unit of the computing system 2202. Further, any instance of the computer-readable storage media 2206 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 2202 utilizes any instance of the computer-readable storage media 2206 in different ways. For example, in some implementations, any instance of the computer-readable storage media 2206 represents a hardware memory unit (such as random access memory (RAM)) for storing information during execution of a program by the computing system 2202, and/or a hardware storage unit (such as a hard disk) for retaining/archiving information on a more permanent basis. In the latter case, the computing system 2202 also includes one or more drive mechanisms 2210 (such as a hard drive mechanism) for storing and retrieving information from an instance of the computer-readable storage media 2206.

In some implementations, the computing system 2202 performs any of the functions described above when the processing system 2204 executes computer-readable instructions stored in any instance of the computer-readable storage media 2206. For instance, in some implementations, the computing system 2202 carries out computer-readable instructions to perform each block of the processes described with reference to FIGS. 19 and 20. FIG. 22 generally indicates that hardware logic circuitry 2212 includes any combination of the processing system 2204 and the computer-readable storage media 2206.

In addition, or alternatively, the processing system 2204 includes one or more other configurable logic units that perform operations using a collection of logic gates, such as field-programmable gate arrays (FPGAs), etc. In these implementations, the processing system 2204 effectively incorporates a storage device that stores computer-readable instructions, insofar as the configurable logic units are configured to execute the instructions and therefore embody or store these instructions.

In some cases (e.g., in the case in which the computing system 2202 represents a user computing device), the computing system 2202 also includes an input/output interface 2214 for receiving various inputs (via input devices 2216), and for providing various outputs (via output devices 2218). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 2220 and an associated graphical user interface presentation (GUI) 2222. The display device 2220 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 2202 also includes one or more network interfaces 2224 for exchanging data with other devices via one or more communication conduits 2226. One or more communication buses 2228 communicatively couple the above-described units together.

The communication conduit(s) 2226 is implemented in any manner, e.g., by a local area computer network, a wide area computer network (e.g., the Internet), point-to-point connections, or any combination thereof. The communication conduit(s) 2226 include any combination of hardwired links, wireless links, routers, gateway functionality, name servers, etc., governed by any protocol or combination of protocols.

FIG. 22 shows the computing system 2202 as being composed of a discrete collection of separate units. In some cases, the collection of units corresponds to discrete hardware units provided in a computing device chassis having any form factor. FIG. 22 shows illustrative form factors in its bottom portion. In other cases, the computing system 2202 includes a hardware logic unit that integrates the functions of two or more of the units shown in FIG. 22. For instance, in some implementations, the computing system 2202 includes a system on a chip (SoC or SOC), corresponding to an integrated circuit that combines the functions of two or more of the units shown in FIG. 22.

The following summary provides a set of illustrative examples of the technology set forth herein.

(A1) According to one aspect, a method (e.g., the process 1802) is described for supplementing an input image (e.g., the input image 106). The method includes receiving (e.g., in block 1804) the input image, and producing (e.g., in block 1806) result information based on the input image that specifies an object to be placed in the input image and a location at which to place the object in the input image, the object and/or the location being identified using a machine-trained model (e.g., the machine-trained model 110). The producing is performed independently of an image of the object. The method further includes executing (e.g., in block 1808) a computer-implemented application task based on the result information. The machine-trained model has weights produced by a training process that includes: removing objects in original images; using the machine-trained model to predict the objects that have been removed given the locations of the objects in the original images, and to predict the locations of the objects that have been removed given the objects; and adjusting the weights to increase accuracy at which the machine-trained model subsequently predicts the objects that have been removed and the locations of the objects.

(A2) According to some implementations of the method of A1, the machine-trained model is a classifier model, and the method further includes: receiving an input that identifies the location; identifying scores that identify suitability of placing different candidate objects at the location, selected from a set of candidate objects; and choosing the object to place at the location based on the scores.

(A3) According to some implementations of the method of A1, the machine-trained model is a classifier model, and the method further includes: receiving an input that specifies the object; identifying scores that identify suitability of placing the object at different candidate locations across the input image; and choosing the location at which to place the object based on the scores.

(A4) According to some implementations of the method of A1, the machine-trained model is a classifier model, and the method further includes: identifying scores that identify suitability of placing different candidate objects for each candidate location of a set of candidate locations across the input image; and choosing the object and the location based on the scores.

(A5) According to some implementations of the method of A1, the machine-trained model is a language model that auto-regressively produces the result information. The method further includes: receiving an input that specifies instruction information in textual form; encoding the input image into image embedding information and encoding the instruction information into instruction embedding information; combining the image embedding information and instruction information into combined embedding information; and transforming, using the language model, the combined embedding information into the result information that specifies the object to be placed in the input image and/or the location at which to place the object in the input image.

(A6) According to some implementations of the method of A5, the instruction identifies the object, and provides a request to find the location in the input image from among plural candidate locations.

(A7) According to some implementations of the method of A5, an input is received that identifies the location. The instruction provides a request to select the object to place at the location from among plural candidate objects.

(A8) According to some implementations of the method of A5, the instruction provides a request to select the object and the location from among plural candidate objects and plural candidate locations.

(A9) According to some implementations of any of the methods of A5-A8, the language model is a fine-tuned language model produced by fine-tuning weights of a pretrained language model.

(A10) According to some implementations of any of the methods of A5-A9, the input image is a frame of an input video sequence, and wherein the language model produces result information that specifies a starting frame in which the object first appears in the input video sequence and a trajectory that defines a path of the object over plural frames following the starting frame in the input video sequence.

(A11) According to some implementations of any of the methods of A1-A10, the application task includes synthesizing an output image, using another machine-trained model, based on the result information, the output image including the object placed at the location.

(A12) According to some implementations of any of the methods of A1-A11, the object is a product in a database of products, and wherein the application task includes retrieving additional information regarding the object from the database, generating a presentation of the additional information, and generating a graphical control that allows a user to select the object.

(A13) According to some implementations of any of the methods of A1-A11, the application task includes controlling a robot based on the result information.

(A14) According to some implementations of the method of A13, the object is associated with a physical object, and the location is associated with a location in a physical environment, and wherein the controlling includes instructing the robot to select the physical object and to place the physical object at the location in the environment.

(A15) According to some implementations of any of the methods of A1-A14, the removing performed in the training process includes reconstructing the original images by performing inpainting to remove the objects.

(B1) According to another aspect, a method (e.g., the process 2002) is described for training weights of a machine-trained model (e.g., the machine-trained model 110) of an image-processing system (e.g., the image-processing system 102). The method includes: receiving (e.g., in block 2004) original images in which objects in the original images are identified; removing (e.g., in block 2006) the objects in the original images; in a first task, predicting (e.g., in block 2008) predicting, using the machine-trained model, the objects that have been removed, and comparing the objects that are predicted with ground-truth objects; in a second task, predicting (e.g., in block 2010) using the machine-trained model, locations of the objects that have been removed, and comparing the locations that are predicted with ground-truth locations, the first task and the second task producing loss information; and adjusting (e.g., in block 2012), based on the loss information, weights to increase accuracy at which the machine-trained model subsequently predicts the objects that have been removed and the locations of the objects that have been removed.

(B2) According to some implementations of any of the method of B1, the original images are frames in input video sequences, and the removing removes the objects from the frames of the input video sequences, to produce reconstructed video sequences. Further, the operations include, in a third task, predicting starting frames at which the objects will first appear in the frames of the input video sequences, and comparing the starting frames that are predicted with ground-truth starting frames, and predicting trajectories of the objects over the frames of the input video sequences, and comparing the trajectories that are predicted with ground-truth trajectories. The third task produces additional loss information. The adjusting also adjusts, based on the additional loss information, the weights to increase accuracy at which the machine-trained model subsequently predicts the starting frames and the trajectories.

In yet another aspect, some implementations of the technology described herein include a computing system (e.g., the computing system 2202) that includes a processing system (e.g., the processing system 2204) having a processor. The computing system also includes a storage device (e.g., the computer-readable storage media 2206) for storing computer-readable instructions (e.g., the information 2208). The processing system executes the computer-readable instructions to perform any of the methods described herein (e.g., any individual method of the methods of A1-A15, B1 and B2).

In yet another aspect, some implementations of the technology described herein include a computer-readable storage medium (e.g., the computer-readable storage media 2206) for storing computer-readable instructions (e.g., the information 2208). A processing system (e.g., the processing system 2204) executes the computer-readable instructions to perform any of the operations described herein (e.g., the operations in any individual method of the methods of A1-A15, B1 and B2).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 2212 of FIG. 22. The term “logic” likewise encompasses various physical and tangible mechanisms for performing a task. For instance, each processing-related operation illustrated in the flowcharts of FIGS. 19 and 20 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for supplementing an input image, comprising:
receiving the input image;
producing result information based on the input image that specifies an object to be placed in the input image and a location at which to place the object in the input image, the object and/or the location being identified using a machine-trained model; and
executing a computer-implemented application task based on the result information,
the machine-trained model having weights produced by a training process that includes: removing objects in original images; using the machine-trained model to predict the objects that have been removed given the locations of the objects in the original images, and to predict the locations of the objects that have been removed given the objects; and adjusting the weights to increase accuracy at which the machine-trained model subsequently predicts the objects that have been removed and the locations of the objects.

2. The method of claim 1, wherein the machine-trained model is a classifier model, and wherein the method further comprises:
receiving an input that identifies the location;
identifying scores that identify suitability of placing different candidate objects at the location, selected from a set of candidate objects; and
choosing the object to place at the location based on the scores.

3. The method of claim 1, wherein the machine-trained model is a classifier model, and wherein the method further comprises:
receiving an input that specifies the object;
identifying scores that identify suitability of placing the object at different candidate locations across the input image; and
choosing the location at which to place the object based on the scores.

4. The method of claim 1, wherein the machine-trained model is a classifier model, and wherein the method further comprises:
identifying scores that identify suitability of placing different candidate objects for each candidate location of a set of candidate locations across the input image; and
choosing the object and the location based on the scores.

5. The method of claim 1, wherein the machine-trained model is a language model that auto-regressively produces the result information, and wherein the method further comprises:
receiving an input that specifies instruction information in textual form;
encoding the input image into image embedding information and encoding the instruction information into instruction embedding information;
combining the image embedding information and instruction information into combined embedding information; and
transforming, using the language model, the combined embedding information into the result information that specifies the object to be placed in the input image and/or the location at which to place the object in the input image.

6. The method of claim 5, wherein the instruction identifies the object, and provides a request to select the location in the input image from among plural candidate locations.

7. The method of claim 5, wherein an input is received that identifies the location, and the instruction provides a request to selected the object to place at the location from among plural candidate objects.

8. The method of claim 5, wherein the instruction provides a request to find the object and the location from among plural candidate objects and plural candidate locations.

9. The method of claim 5, wherein the language model is a fine-tuned language model produced by fine-tuning weights of a pretrained language model.

10. The method of claim 5, wherein the input image is a frame of an input video sequence, and wherein the language model produces result information that specifies a starting frame in which the object first appears in the input video sequence and a trajectory that defines a path of the object over plural frames following the starting frame in the input video sequence.

11. The method of claim 1, wherein the application task incudes synthesizing an output image, using another machine-trained model, based on the result information, the output image including the object placed at the location.

12. The method of claim 1, wherein the object is a product in a database of products, and wherein the application task includes retrieving additional information regarding the object from the database, generating a presentation of the additional information, and generating a graphical control that allows a user to select the object.

13. The method of claim 1, wherein the application task includes controlling a robot based on the result information.

14. The method of claim 13, wherein the object is associated with a physical object, and the location is associated with a location in a physical environment, and wherein the controlling includes instructing the robot to select the physical object and to place the physical object at the location in the environment.

15. The method of claim 1, wherein the removing performed in the training process includes reconstructing the original images by performing inpainting to remove the objects.

16. A computing system for training weights of a machine-trained model of an image-processing system, comprising:
an instruction data store for storing computer-readable instructions; and
a processing system for executing the computer-readable instructions in the data store, to perform operations including:
receiving original images in which objects in the original images are identified;
removing the objects in the original images;
in a first task, predicting, using the machine-trained model, the objects that have been removed, and comparing the objects that are predicted with ground-truth objects;
in a second task, predicting, using the machine-trained model, locations of the objects that have been removed, and comparing the locations that are predicted with ground-truth locations,
the first task and the second task producing loss information; and
adjusting, based on the loss information, the weights to increase accuracy at which the machine-trained model subsequently predicts the objects that have been removed and the locations of the objects that have been removed.

17. The computing system of claim 16, wherein the removing includes reconstructing the original images by performing inpainting to remove the objects.

18. The computing system of claim 16,
wherein the original images are frames in input video sequences,
wherein the removing removes the objects from the frames of the input video sequences, to produce reconstructed video sequences,
wherein the operations further include, in a third task, predicting starting frames at which the objects will first appear in the frames of the input video sequences, and comparing the starting frames that are predicted with ground-truth starting frames, and predicting trajectories of the objects over the frames of the input video sequences, and comparing the trajectories that are predicted with ground-truth trajectories,
the third task producing additional loss information, and
wherein the adjusting also adjusts, based on the additional loss information, the weights to increase accuracy at which the machine-trained model subsequently predicts the starting frames and the trajectories.

19. A computer-readable storage medium for storing computer-readable instructions, a processing system executing the computer-readable instructions to perform operations, the operations comprising:
receiving an input image;
producing result information based on the input image that specifies an object to be placed in the input image and a location at which to place the object in the input image,
the producing including a first mode in which a machine-trained model identifies the object based on input that specifies the location, a second mode in which the machine-trained model identifies the location based on input that specifies the object, and a third mode in which the machine-trained model identifies both the object and the location, the producing being performed independently of an image of the object; and
synthesizing an output image based on the result information, the output image including the object placed at the location.

20. The computer-readable storage medium of claim 19, wherein the input image is part of an input sequence, and wherein the producing includes a fourth mode in which the machine-trained model identifies a starting frame in the input video sequence in which the object first appears and a trajectory of the object over plural subsequent frames of the input video sequence.
